(19) United States
(12) Patent Application Publication
(10) Pub. No.: US 2005/0076300 A1
(43) Pub. Date: Apr. 7, 2005

(54) Block marker system

(75) Inventor: Anthony Edward Martinez, Augustine, FL (US)

Correspondence Address: Robert V. Wilder;Attorney at Law, 4235 Kingsburg Drive, Round Rock, TX, 78681, US

(73) Assignee: International Business Machines Corporation, Armonk, NY (US)

(21) Appl. No.: 10/677,657

(22) Filed: Oct. 2, 2003

(51) Int. Cl. G06F 17/24; G06F 3/00

(52) U.S. Cl. 715/539; 715/822; 715/823; 715/818; 715/817; 715/859; 715/772

(57) ABSTRACT

A method and implementing computer system are provided for enabling a document section block selection including the insertion and display of endpoint markers at the beginning and end of the selected block. In an exemplary embodiment, a selected block of text may then be either shortened or extended by using a pointing device to move a corresponding displayed endpoint marker in a selected direction.

### FIELD OF THE INVENTION

The present invention relates generally to information processing systems and more particularly to a methodology and implementation for facilitating block selection in word processing and related applications.

### BACKGROUND OF THE INVENTION

Currently, text selection mechanisms in word processing and other applications are fairly simple and straight forward. For example in windowing interfaces, a displayed cursor or pointer is placed at a start point in a text where a block is to begin. The cursor is then dragged to the block endpoint, a depressed mouse button is then released and the selected text section is highlighted to identify the selected text segment upon which further processing operations (e.g. “copy” or “cut” or “cut-and-paste”) are to be accomplished. However, once a selection is made, the act of modifying that selection becomes cumbersome, and typically involves the use of modifier keys such as SHIFT and/or CONTROL keys.

The implementation is also inconsistent with the same OS platform. For example, in some word processing applications, a selection can only be extended, holding the SHIFT key down while dragging to either direction of the initial insertion point. Extension of the selected block will not work in both directions. Some applications allow use of the CONTROL key, in addition to SHIFT, to extend the selection but the behavior is different from SHIFT, and this implementation is yet another modifier key to learn.

Thus, there is a need for an improved methodology and system for enabling text block selections which are easily implemented and in which selected blocks are easily modified and extended after being initially defined.

### SUMMARY OF THE INVENTION

A method and implementing computer system are provided for enabling a block selection including the insertion and display of endpoint markers at the beginning and end of the selected text/graphics block of information. In an exemplary embodiment, a selected block of text may then be either shortened or extended by using a pointing device to move a corresponding displayed endpoint marker in a selected direction.

### BRIEF DESCRIPTION OF THE DRAWINGS

A better understanding of the present invention can be obtained when the following detailed description of a preferred embodiment is considered in conjunction with the following drawings, in which:

FIG. 1 is a computer system which may be used in an exemplary implementation of the present invention;

FIG. 2 is a schematic block diagram illustrating several of the major components of an exemplary computer system;

FIG. 3 illustrates an example of a text manipulation useful in explaining an operation of the present invention;

FIG. 4 illustrates the insertion of endpoint markers in connection with an exemplary operation implementing the present invention;

FIG. 5 illustrates an exemplary operation using a methodology of the present invention;

FIG. 6 illustrates another exemplary operation using a methodology of the present invention;

FIG. 7 illustrates another exemplary operation using a methodology of the present invention;

FIG. 8 illustrates the use of a follow-on function in connection with the blocking technique of the present invention; and

FIG. 9 is a flow chart illustrating a high level operational flow in an exemplary implementation of the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

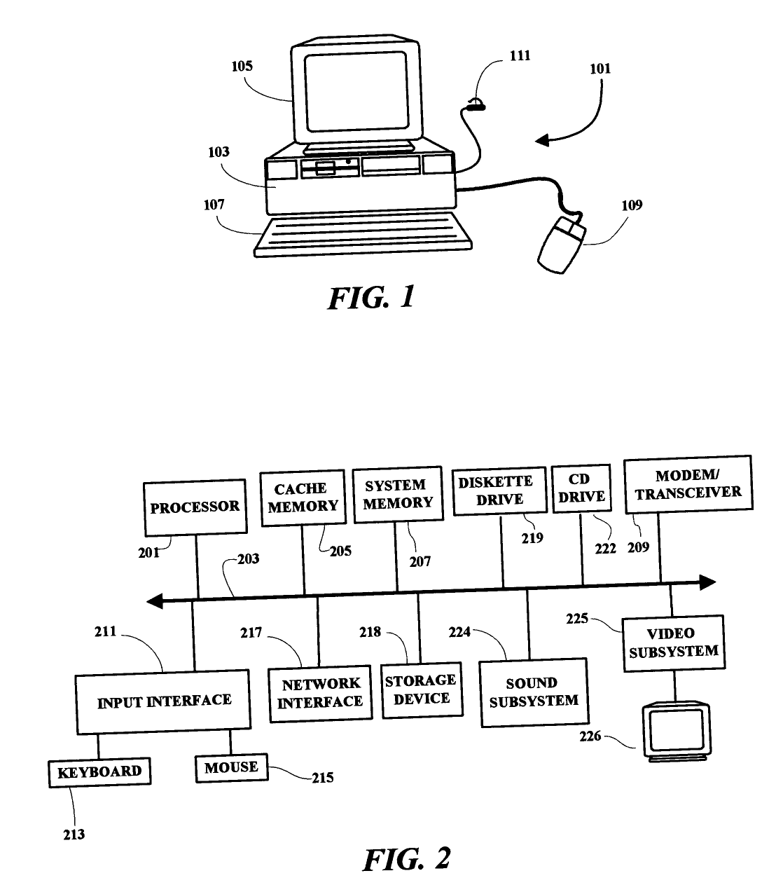

With reference to FIG. 1, the various methods discussed herein may be implemented within a stand-alone computer system or over a computer network. A networked system may include a server and one or more computer terminals. The computer terminals may comprise either a workstation, personal computer (PC), laptop computer or a wireless computer system or other device which has word processing capabilities, including but not limited to cellular or wireless telephone devices and personal digital assistants (PDAs). In general, an implementing computer system may include any computer system and may be implemented with one or several processors in a wireless system or a hard-wired multi-bus system, or within a network of similar systems.

In the FIG. 1 example, an exemplary computer system includes a terminal 101 and a processor unit 103 which is typically arranged for housing a processor circuit along with other component devices and subsystems of the computer terminal 101. The computer terminal 101 also includes a monitor unit 105, a keyboard 107 and a mouse or pointing device 109, which are all interconnected with the computer terminal illustrated. Other input devices such as a stylus, used with a menu-driven touch-sensitive display may also be used instead of or in addition to the mouse device 109. Also shown is a connector 111 which is arranged for connecting a modem within the computer terminal to a communication line such as a telephone line in the present example. The computer terminal may also be hard-wired through other network servers and/or implemented in a cellular or other wireless system. The basic components shown in FIG. 1 may also be implemented in a laptop computer or other hand-held device.

Several of the major components of the terminal 101 are illustrated in FIG. 2. A processor circuit 201 is connected to a system bus 203 which may be any host system bus. It is noted that the processing methodology disclosed herein will apply to many different bus and/or network configurations. A cache memory device 205 and a system memory unit 207 are also connected to the bus 203. A modem and/or transceiver 209 is arranged for connection to external devices and/or remote networks. The modem 209, in the present example, selectively enables the computer terminal 101 to establish a communication link and initiate communication with networked servers through a network connection such as the Internet.

The system bus 203 is also connected through an input interface circuit 211 to a keyboard 213 and a mouse or other pointing device 215. The bus 203 may also be coupled through a hard-wired network interface subsystem 217 which may, in turn, be coupled through a wireless or hard-wired connection to a network of servers and mail servers on the world wide web. A diskette drive unit 219 and a CD drive unit 222 are also shown as being coupled to the bus 203. A video subsystem 225, which may include a graphics subsystem, is connected to a display device 226. A storage device 218, which may comprise a hard drive unit and/or a flash memory device, is also coupled to the bus 203. The diskette drive unit 219 as well as the CD drive 222 provide a means by which individual diskette or CD programs may be loaded into memory or on to the hard drive, for selective execution by the computer terminal 101. As is well known, program diskettes and CDs containing application programs represented by magnetic indicia on the diskette or optical indicia on a CD, may be read from the diskette or CD drive into memory, and the computer system is selectively operable to read such magnetic or optical indicia and create program signals. Such program signals are selectively effective to cause the computer system to present displays on the screen of a display device and generally respond to user inputs in accordance with the functional flow of an application program.

It is understood that the present invention applies equally well to any electronic data input system including, but not limited to, PC systems, as well as wireless and/or cellular messaging or input systems. The present invention applies to all applications which require the input and manipulation of information by a user. Such applications may be PC-based, PDA-based or Internet-based, i.e. implementing code may be included in PC-based computer terminal applications or resident at servers remote from a user terminal, or both. The present invention simplifies the act of selecting and extending the selection of text in a computer interface by flagging the endpoints of the selected text with interactive markers. The markers can be moved by mouse-drag action, and can be enabled for keyboard or speech operation (for mobility-impaired users). The embodiments of the displayed markers can take on many forms. For the sake of simplicity, the markers are illustrated herein as simple blocks which may be displayed at the beginning and endpoints of a selected block of text. The markers may also be embodied as brackets or similar sets of markers from which the beginning and ending of a text selection can be distinguished, i.e. opening-right bracket as the beginning of a block selection and opening-left bracket as the end marker for a selected block of text. The markers may also be opaque or semi-transparent, with the semi-transparent markers having minimal obscuring impact on the text being edited.

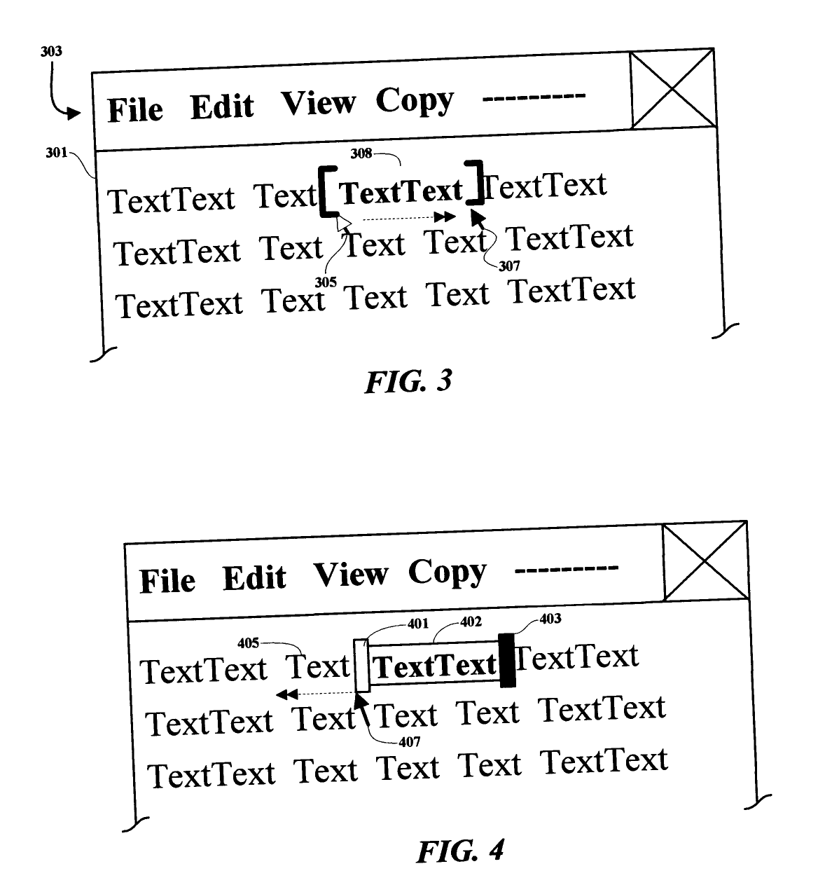

As shown in FIG. 3, a word processing application screen is displayed 301 which includes a menu bar 303. Items on the menu bar 303 may be selected by moving a pointer 307 to the selected item on the menu bar 303 and depressing the left-hand button on the controlling mouse device (109). As illustrated, the menu bar includes a listing of categorized functions under various headings such as “File”, “Edit”, “View” and “Copy”. Of particular interest in connection with the present invention is the “Copy” function which, when selected, enables a user to copy a selected block of text for further processing, such as “Pasting” the selected block at another location in the document being displayed or in another file. In the exemplary embodiment, the text selection is accomplished by manipulating a mouse device to place a displayed pointer at a point in a text where a block is to begin, e.g. 305, and depressing and holding down a switch on the mouse device while “dragging” the displayed cursor or pointer, by moving the mouse device, to the endpoint e.g. 307 to define the selected block of text 308. The selected block of text may then be processed by, for example, a “Copy” and “Paste” process or other selected function. In FIG. 3, the displayed endpoint markers are in the form of brackets so that a user can tell which is the beginning marker and which is the ending marker. When a block is started by a user the open-to-the-right bracket is inserted and displayed and when the user ends the selected block by releasing the mouse button, the open-to-the-left bracket is inserted and displayed. The selected text block in this example is also highlighted by emboldened text.

Other conventions may also be implemented such as having a blank marker at one end and a darkened marker at the other end of a selected block of text as is illustrated in the remaining drawings.

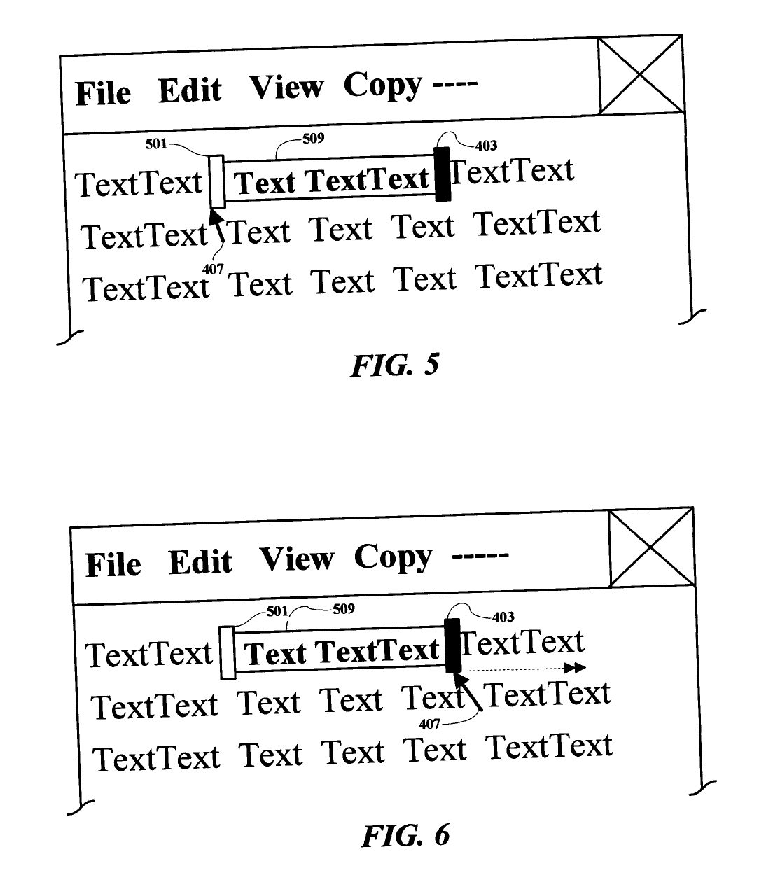

In accordance with the present invention, the interactive markers are displayed at the endpoints of a block of selected text and the markers are selectively movable to redefine the selected block of text. As shown in FIG. 4, marker 401 is displayed to mark the beginning of a selected block of text 402 and marker 403 is displayed to mark the endpoint of the selected block of text 402. As previously noted, the markers 401 and 403 can be implemented in other formats such as opaque and/or semi-transparent brackets. As shown, when it is desired to extend the selected block of text by including text to the left of the original block 402, the pointer 407 is moved to the left to include the additional text 405 and the mouse button is released thereby causing the leftmost or beginning point marker to move to the left to the point indicated by marker 501 in FIG. 5 to define a new block 509. The unmoved marker 403 remains in its initial position until moved by the user.

In FIG. 6, when it is desired to extend a selected block of text 509 to the right to include additional text, the right-hand marker 403 is moved to the right by pointing to and dragging the endpoint marker 403 using the mouse as indicated and the left-side or beginning point marker 501 remains in place.

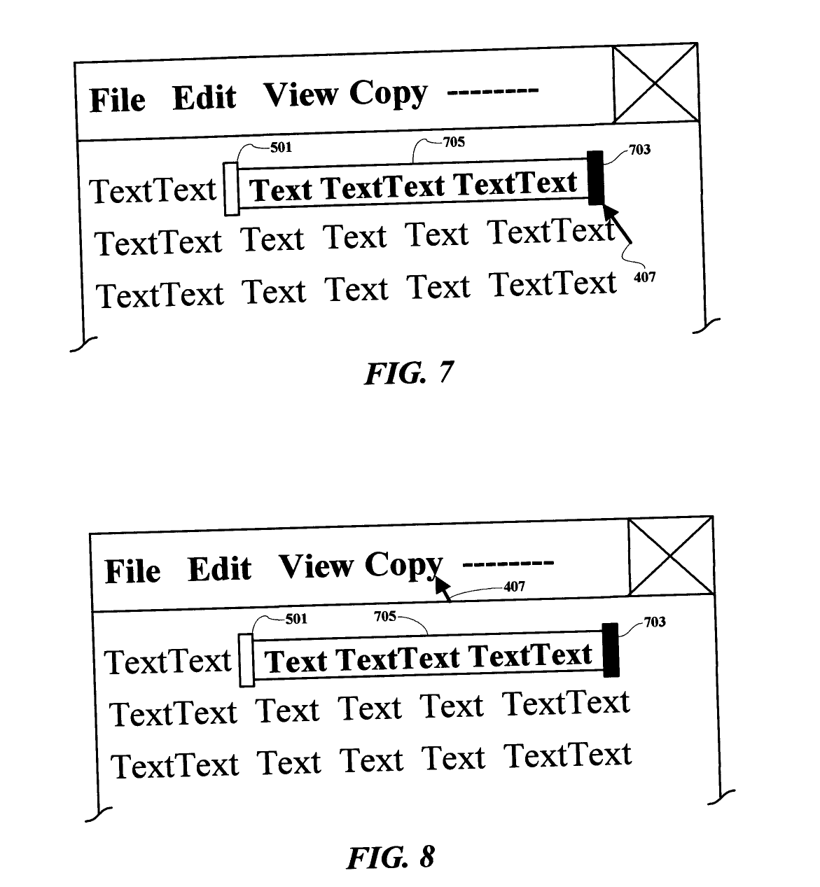

As shown in FIG. 7, when the endpoint marker 703 has been moved by moving the pointer 407 to the new position to include additional text, the mouse button is released and the extended block of selected text 705 is highlighted and defined by markers 501 and 703. After having extended an initially designated selected block of text, a user is enabled to use the pointer to select the “Copy” function as shown in FIG. 8 to copy the selected block of text for further processing. It is noted that either endpoint marker 501 or 703 may be moved in either direction in order to shorten or extend a previously defined selected block of text.

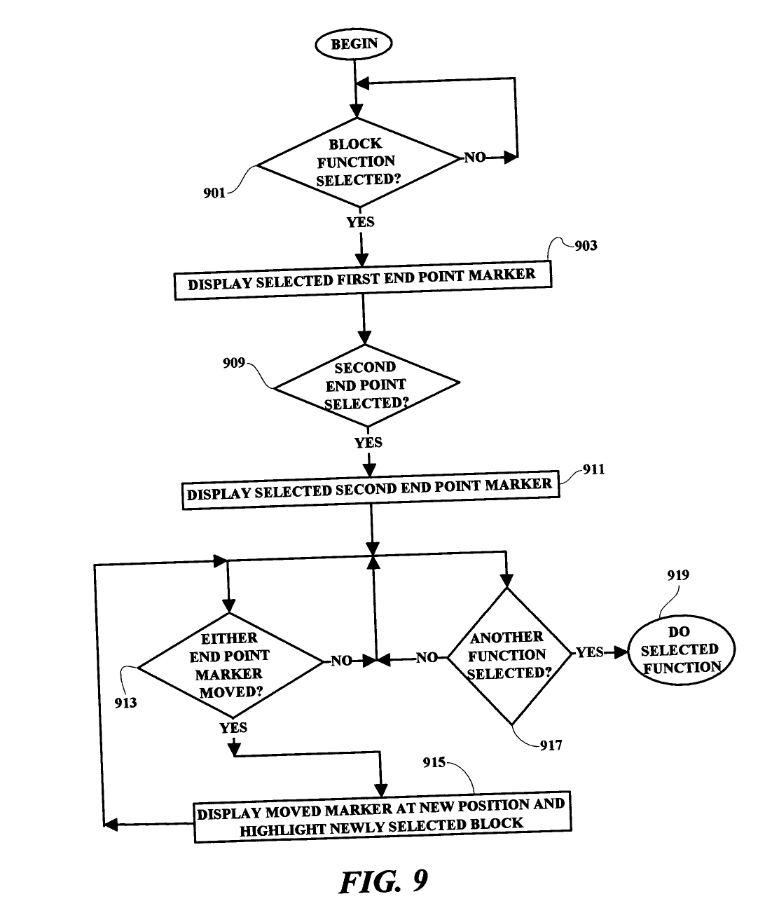

As shown in the flow chart illustrated in FIG. 9, the process begins by determining 901 that a blocking function has been selected by a user of a word processing program for example. This is accomplished when a user places a cursor or pointer at a point in a section of text and begins to “drag” the controlling mouse device to another location in a displayed document. At that time, a beginning point or first end point marker is displayed 903. When the user moves the mouse to another location and releases the mouse button, a second endpoint has been selected 909 and a second end point marker is displayed 911 to mark the selected block of text. Thereafter, a user may selectively extend the marked block of text in either direction by using the pointer and pointing to and dragging a corresponding endpoint marker as shown in FIGS. 3-7. To facilitate moving the markers and executing the block-extending operation, the screen cursor, which may normally be only a vertical line in the word processing application, may be changed to appear as a pointer as shown in the Figures when the cursor is positioned over one of the endpoint markers. When it is determined that either endpoint marker has been selected and moved 913 for extending the selected block of text, the selected endpoint marker will be displayed at the new position 915 and the newly defined block of text will be highlighted. Thereafter when a new function in the word processing application is selected 917, such as a “Copy” function, the processing continues by accomplishing the selected function 919 until the next block function is selected 901. Although not shown in the flow chart for the sake of simplicity, it is understood that the blocking function may be exited at any time by merely clicking on another area of a displayed document without dragging the cursor.

It is noted that although the present invention is herein described in a word processing application example, the principles disclosed also apply to combination documents including text and graphics as well as to solely graphic applications wherein sections of displays can be marked and extended for further processing, including but not limited to graphic image enlargement and/or deletion functions.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

1. A method for facilitating modification of the extent of a selected block of information in a displayed presentation for further processing of said block, said method comprising:
receiving a first input from a user for defining a first endpoint of said selected block of information;
displaying a first endpoint marker at said first endpoint;
receiving a second input from said user for defining a second endpoint of said selected block of information;
displaying a second endpoint marker at said second endpoint, said selected block of information being defined by said first and second endpoint markers; and
enabling said user to move either said first or second endpoint markers in order to correspondingly modify said extent of said selected block of information.

2. The method as set forth in claim 1 wherein at least one of said first and second endpoint markers is displayed as a rectangular block.

3. The method as set forth in claim 1 wherein said first endpoint marker is visibly different from said second endpoint marker.

4. The method as set forth in claim 3 wherein said first endpoint marker is visibly designed to indicate a beginning of said selected block of information.

5. The method as set forth in claim 4 wherein said second endpoint marker is visibly designed to indicate an end of said selected block of information.

6. The method as set forth in claim 1 wherein at least one of said first and second endpoint markers is displayed as a bracket symbol.

7. The method as set forth in claim 1 wherein at least one of said endpoint markers is displayed as a semi-transparent marker overlaying displayed content to enable a semi-transparent view of said displayed content as viewed through said one of said endpoint markers.

8. The method as set forth in claim 1 wherein said enabling comprises responding to a user's movement of a mouse device to enable a corresponding movement of a displayed cursor to a selected one of said first or second endpoint markers, said method further being operable in response to an actuation of a switch associated with said mouse device in combination with a movement of said mouse device to move said selected one of said first or second endpoint markers in response to a movement of said mouse device to a new location thereby changing said extent of said selected block of information.

9. The method as set forth in claim 8 wherein said selected block of information is shortened in response to movement of said one of said first or second endpoint markers.

10. The method as set forth in claim 8 wherein said selected block of information is extended in response to movement of said one of said first or second endpoint markers.

11. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being selectively operable to facilitate a selection of a block of information in a displayed presentation for further processing by effecting the steps of:
receiving a first input from a user for defining a first endpoint of said selected block of information;
displaying a first endpoint marker at said first endpoint;
receiving a second input from said user for defining a second endpoint of said selected block of information;
displaying a second endpoint marker at said second endpoint, said selected block of information being defined by said first and second endpoint markers; and
enabling said user to move either said first or second endpoint markers in order to correspondingly modify said extent of said selected block of information.

12. The medium as set forth in claim 11 wherein at least one of said first and second endpoint markers is displayed as a rectangular block.

13. The medium as set forth in claim 11 wherein said first endpoint marker is visibly different from said second endpoint marker.

14. The medium as set forth in claim 13 wherein said first endpoint marker is visibly designed to indicate a beginning of said selected block of information.

15. The medium as set forth in claim 14 wherein said second endpoint marker is visibly designed to indicate an end of said selected block of information.

16. The medium as set forth in claim 11 wherein at least one of said first and second endpoint markers is displayed as a bracket symbol.

17. The medium as set forth in claim 11 wherein at least one of said endpoint markers is displayed as a semi-transparent marker overlaying displayed content to enable a semi-transparent view of said displayed content as viewed through said one of said endpoint markers.

18. The medium as set forth in claim 11 wherein said enabling comprises responding to a user's movement of a mouse device to enable a corresponding movement of a displayed cursor to a selected one of said first or second endpoint markers, and, in response to an actuation of a switch associated with said mouse device in combination with a movement of said mouse device, to move said selected one of said first or second endpoint markers to a new location thereby changing said extent of said selected block of information.

19. The medium as set forth in claim 18 wherein said selected block of information is shortened in response to movement of said one of said first or second endpoint markers.

20. The medium as set forth in claim 18 wherein said selected block of information is extended in response to movement of said one of said first or second endpoint markers.

21. A system for processing a selected block of information in a displayed presentation, said system comprising:
a system bus;
a CPU device connected to said system bus;
an input device connected to said system bus, said input device being arranged to enable user input to said system;
a display device connected to said system bus; and
memory means connected to said system bus, said memory means containing code executable by said CPU device for receiving a first user input from a user for defining a first endpoint of a selected block of information and displaying a first endpoint marker at said first endpoint, said system being further operable for receiving a second input from said user for defining a second endpoint of said selected block of information and displaying a second endpoint marker at said second endpoint, said selected block of information being defined by said first and second endpoint markers, said system being further operable for enabling said user to move either said first or second endpoint markers by using said input device in order to correspondingly modify said extent of said selected block of information.
